(19) United States
(12) Patent Application Publication
(10) Pub. No.: US 2012/0278329 A1
(43) Pub. Date: Nov. 1, 2012

(54) TRACKING FEEDS IN A SOCIAL NETWORK

(75) Inventors: Geoffrey Borggaard, Lincoln, MA (US); Ivaylo Vladimirov Popov, Arlington, TX (US)

(73) Assignee: GOOGLE INC., Mountain View, CA (US)

(21) Appl. No.: 13/109,762

(22) Filed: May 17, 2011

Related U.S. Application Data
(60) Provisional application No. 61/480,492, filed on Apr. 29, 2011.

(51) Int. Cl. G06F 17/30

(52) U.S. Cl. 707/738; 707/E17.046; 707/E17.109

(57) ABSTRACT

A system and method for tracking feeds in a social network is disclosed. The system includes a feed module and a personalization module. The feed module is communicatively coupled to the social network. The feed module is configured to receive a social information feed from the social network. The personalization module is communicatively coupled to the feed module to receive the social information feed from the feed module. The personalization module retrieves a category. The personalization module organizes the social information feed into a categorized feed based at least in part on the category. The personalization module extracts a feature based at least in part on a user query. The personalization module queries the categorized feed based at least in part on the feature to generate a personalized feed. The personalization module outputs the personalized feed to the user or a third party.

### CROSS REFERENCE TO RELATED APPLICATIONS

This application claims priority under 35 USC §119(e) to U.S. Application No. 61/480,492, entitled “Tracking Feeds in a Social Network” filed Apr. 29, 2011, the entirety of which is herein incorporated by reference.

### BACKGROUND

The specification relates to a system and method for processing feeds in a social network. In particular, the specification relates to tracking feeds for a user in a social network.

Many people use a variety of different social networks. These different social networks include dozens, hundreds, thousands or even millions of real-time updates and posts every second. The overwhelming number of updates and posts is referred to as a “firehose of information” because of the huge volume of information included in the updates and posts (the information included in the updates and posts is referred to herein as “the information included in the firehose”). Some services seek to aggregate this firehose of information so that it is available via a single service (e.g., via a single tracking service website). However, existing tracking services do not tailor the information included in the firehose so that it is possible for a user to obtain only a portion of the information that the user finds interesting.

A first problem present in existing tracking services is that they only track the information included in the firehose by pre-defined topics and the tracking result is not personalized to meet the needs of a particular user.

A second problem with existing tracking services is that they track the information included in the firehose based on the information that is explicitly provided by a user and nothing else. For example, the existing solutions do not allow tracking the information included in the firehose based on profile information describing a user such that the tracking result is personalized for the user even if the user explicitly provides no information for the tracking process.

### SUMMARY OF THE INVENTION

In some examples the specification describes a system and method for tracking feeds in a social network. The system comprises a feed module and a personalization module. The feed module is communicatively coupled to the social network. The feed module is configured to receive a social information feed from the social network. In one embodiment, the social information feed contains anonymized social data. The personalization module is communicatively coupled to the feed module to receive the social information feed from the feed module. The personalization module retrieves a category, such as a topic or location of a post published in the social network. The personalization module organizes the social information feed into a categorized feed based at least in part on the category. The personalization module extracts a feature based on a user query. The personalization module filters the categorized feed based at least in part on the feature to generate a personalized feed. In one embodiment, the filtering is further based on a geographical location including a location specified by the user and a location determined from the profile information describing the user. The personalization module outputs the personalized feed to the user or a third party.

In one embodiment, the filtering is also based at least in part on profile information describing the user including demographic information, an interest, a hobby, an address, an educational background, a working experience, a social graph, a website membership, a blog membership, a website browsing history, a querying history in a search engine, a newsfeed subscription and a website connection. In one embodiment, the feature extracted from the user query is a keyword generated for the user based at least in part on the profile information.

The specification also includes a computer program product comprising a non-transitory computer readable medium storing a computer readable program and a number of novel methods including a method for retrieving a category, receiving a social information feed from the social network, organizing the social information feed into a categorized feed based at least in part on the category, extracting a feature based at least in part on profile information describing a user and filtering the categorized feed based at least in part on the feature to generate a personalized feed.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a high-level block diagram illustrating a system for tracking feeds in a social network according to one embodiment.

FIG. 2 is a block diagram illustrating a personalization module according to one embodiment.

FIG. 3 is a flow diagram of a method for tracking feeds in a social network according to one embodiment.

FIG. 4 is a flow diagram of a method for tracking feeds in a social network according to another embodiment.

### DETAILED DESCRIPTION OF THE PREFERRED EMBODIMENTS

A system and method for tracking feeds in a social network is described below. In the following description, for purposes of explanation, numerous specific details are set forth in order to provide a thorough understanding. It will be apparent, however, to one skilled in the art that the specification can be practiced without these specific details. In other instances, structures and devices are shown in block diagram form in order to avoid obscuring the description. For example, the specification is described in one embodiment below with reference to user interfaces and particular hardware. However, the description applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification includes an entirely hardware embodiment, an entirely software embodiment or an embodiment containing both hardware and software elements. In a preferred embodiment, the description is implemented in software, which includes but is not limited to firmware, resident software, microcode, etc.

Furthermore, the description includes a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

### System Overview

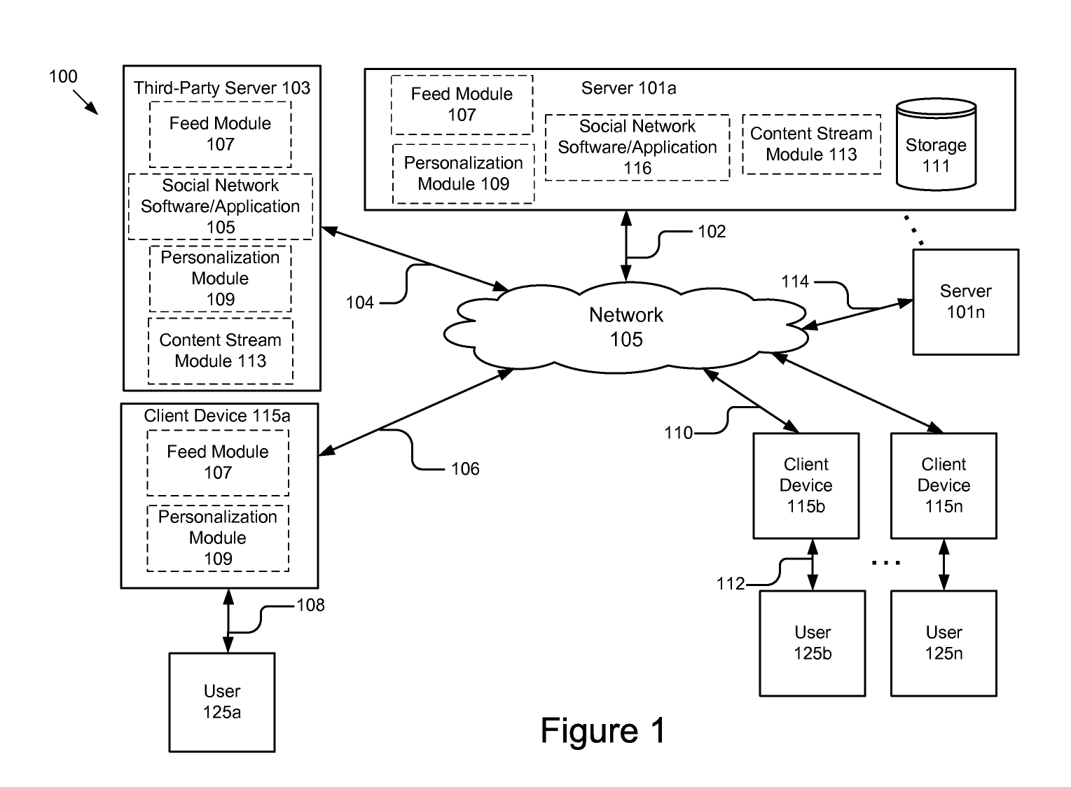

FIG. 1 illustrates a block diagram of a system 100 for tracking feeds in a social network according to one embodiment. The illustrated embodiment of the system 100 includes one or more servers 101a, 101n, a third-party server 103 and client devices 115a, 115b, 115n that are accessed by users 125a, 125b, 125n. In the illustrated embodiment, these entities are communicatively coupled via a network 105. Although only two servers 101a, 101n are illustrated, persons having ordinary skill in the art will recognize that any number of servers 101n are communicatively coupled to the network 105. Although only three client devices 115a, 115b, 115n are illustrated, persons having ordinary skill in the art will also recognize that any number of client devices 115n are available to any number of users 125n. Persons having ordinary skill in the art will also appreciate that any number of users 125n can use (or access) a single client device 115n. Furthermore, while only one network 105 is coupled to the client devices 115a, 115b, 115n, the server 101a, 101n and the third-party server 103, in one embodiment any number of networks 105 are connected to the server 101a, 101n and the third-party server 103. Persons having ordinary skill in the art will also appreciate that while only one third-party server 103 is depicted in FIG. 1, the system 100 could include one or more third-party servers 103.

The network 105 is a conventional type, wired or wireless, and may have any number of configurations such as a star configuration, token ring configuration or other configurations known to those skilled in the art. In one embodiment, the network 105 comprises one or more of a local area network (LAN), a wide area network (WAN) (e.g., the Internet), and/or any other interconnected data path across which multiple devices communicate. In another embodiment, the network 105 is a peer-to-peer network. The network 105 is coupled to or includes portions of a telecommunications network for sending data in a variety of different communication protocols. For example, the network is a 3G network or a 4G network. In yet another embodiment, the network 105 includes Bluetooth communication networks or a cellular communications network for sending and receiving data such as via short messaging service (SMS), multimedia messaging service (MMS), hypertext transfer protocol (HTTP), direct data connection, wireless application protocol (WAP), email, etc.

In the illustrated embodiment, the servers 101a, 101n are communicatively coupled to the network 105 via signal lines 102 and 114, respectively. The third-party server 103 is communicatively coupled to the network 105 via signal line 104. The client device 115a is communicatively coupled to the network 105 via signal line 106. The user 125a interacts with the client device 115a as represented by signal line 108. Similarly, the client device 115b is coupled to the network 105 via signal line 110. The user 125b interacts with the client device 115b as represented by signal line 112. Client device 115n and user 125n are coupled and interact in a similar manner.

The server 101a, 101n is a hardware server device. For example, the server 101a, 101n is a hardware server operated by Google® of Mountain View, Calif. In one embodiment, the server 101a, 101n sends and receives data to and from one or more of the client devices 115a, 115b, 115n via the network 105. For example, the server 101a, 101n is a hardware server that provides a microblogging service such as Google® Buzz to the client devices 115a, 115b, 115n. A person having ordinary skill in the art will recognize that in one embodiment the server 101a, 101n is configured to provide different services and/or functionality to the client devices 115a, 115b, 115n.

In one embodiment, the server 101a, 101n comprises, among other things, a feed module 107, a social network software/application 116, a personalization module 109, a content stream module 113 and a storage device 111. Here, the feed module 107 and the personalization module 109 are depicted by a rectangle formed from a dashed line to indicate that the feed module 107 and the personalization module 109 are comprised within the server 101a, 101n, the third-party server 103 and/or the client device 115a, 115b, 115n. For example, in one embodiment the feed module 107 and the personalization module 109 are comprised within the server 101a, 101n, while in another embodiment the feed module 107 is comprised within the third-party server 103 and the personalization module 109 is comprised within the client device 115a, 115b, 115n. Similarly, the social network software/application 116 and the content stream module 113 are comprised within the server 101a, 101n and/or the third-party server 103. In one embodiment, the social network software/application 116 is comprised within the server 101a, 101n and the content stream module 113 is comprised within the third-party server 103, while in another embodiment the social network software/application 116 is comprised within the third-party server 103 and the content stream module 113 is comprised within the server 101a, 101n. In another embodiment, the server 101a, 101n additionally comprises a processor (not pictured), a memory (not pictured) and other components conventional to a hardware server device.

The storage device 111 is a non-transitory memory that stores data such as profile information describing a user 125a, 125b, 125n. The profile information is collected upon user consent. In some implementations, a user is prompted to explicitly allow data collection. Further, the user may opt-in or opt-out of participating in such data collection activities. The profile information is any information related to the user 125a, 125b, 125n such as personal interests and hobbies, etc. For example, the storage device 111 stores likes and dislikes of the user 125a, 125b, 125n. Further examples of the profile information include, but are not limited to: demographic information, an address, education background, working experience, a social graph, website memberships, blog memberships, website browsing history, querying history in a search engine, a newsfeed subscription and website connections. In one embodiment, the profile information is provided explicitly by the user 125a, 125b, 125n. In another embodiment, the profile information is implicitly gathered by the server 101a, 101n.

In one embodiment, the storage device 111 is configured to provide the profile information describing the user 125a, 125b, 125n to the personalization module 109. The storage device 111 is communicatively coupled to the personalization module 109. In one embodiment, the storage device 111 is communicatively coupled to the network 105 and optionally communicatively coupled to one or more of the third-party server 103 and the client device 115a, 115b, 115n via the network 105.

The feed module 107 is code and routines that, when executed by a processor (not pictured), retrieves a social information feed from one or more social networks provided by the social network software/application 116 and the content stream module 113. For example, the feed module 107 collects a social information feed from one or more social networks. In one embodiment, the social information feed is anonymized prior to collection. A social network is any type of social structure where the users are connected by a common feature. The common feature includes friendship, family, work, an interest, etc. The common features are provided by one or more social networking systems including explicitly-defined relationships and relationships implied by social connections with other online users, where the relationships form a social graph. In some examples, the social graph reflects a mapping of these users and how they are related. The social network is provided by one or more social network software/applications 116 stored on one or more servers such as the server 101a, server 101n and/or the third-party server 103. In one embodiment, the social network software/application 116 is configured to provide all or a subset of the social information feed to the feed module 107.

The content stream module 113 is an optional feature of the system 100. In one embodiment, the content stream module 113 receives data for generating a content stream from one or more social network software/applications 116 and various different heterogeneous data sources. In one embodiment, the content stream module 113 receives data from a third-party server 103, a server 101a, 101n, user devices 115a, 115b, 115n, a search server (not pictured) that is coupled to the network 105 via signal line (not pictured), an entertainment server (not pictured) that is coupled to the network 105 via signal line (not pictured), a ratings server (not pictured; e.g., for Google® Hotpot or other ratings websites) that is coupled to the network 105 via signal line (not pictured), an email server (not pictured) that is coupled to the network 105 via signal line (not pictured) and a social graph (not pictured) that is coupled to the network 105 via signal line (not pictured). In one embodiment, the search server (not pictured) includes a search engine for retrieving results that match search terms from the Internet. In one embodiment, the search engine is powered by Google®. The content stream module 113 generates a social information feed based on the information from the social network software/applications 116 and/or the heterogeneous data sources. In one embodiment, the content stream module 113 communicates with the feed module 107 to send all or a subset of the social information feed to the feed module 107.

The social information feed is a feed that includes all actions any users have taken on the social network in real-time and/or actions indicated by the heterogeneous data sources as long as the users have consented to collection of the actions. In another embodiment, the social information feed is anonymized prior to collection. For example, the feed module 107 receives all or a subset of a social network feed that includes information about users that opt-in to having data collected from user input and/or prior actions of a user across the various heterogeneous data sources including search (such as web, video, news, maps, alerts), entertainment (such as news, video, a personalized homepage, blogs, a reader, gadget subscriptions), social activity (such as interactions through email, profile information, text messaging such as short message service (SMS), microblogs, geographical locations, comments on photos, a social graph and other social networking information) and activity on third-party sites (such as websites that provide ratings, reviews and social networks where users indicate that they approve of content).

In one embodiment, the feed module 107 is stored on a non-transitory memory associated with the server 101a, 101n. Persons having ordinary skill in the art will recognize that, in other embodiments, the feed module 107 is stored on a non-transitory memory associated with the third-party server 103 or the client device 125a, 125b, 125n. The feed module 107 is communicatively coupled to the network 105 and the personalization module 109. In one embodiment, the feed module 107 receives all or a subset of the social information feed from one or more of the social network software/application 116 and the content stream module 113 via the network 105. In one embodiment, the feed module 107 is configured to communicate with the personalization module 109 and provide the social information feed to the personalization module 109.

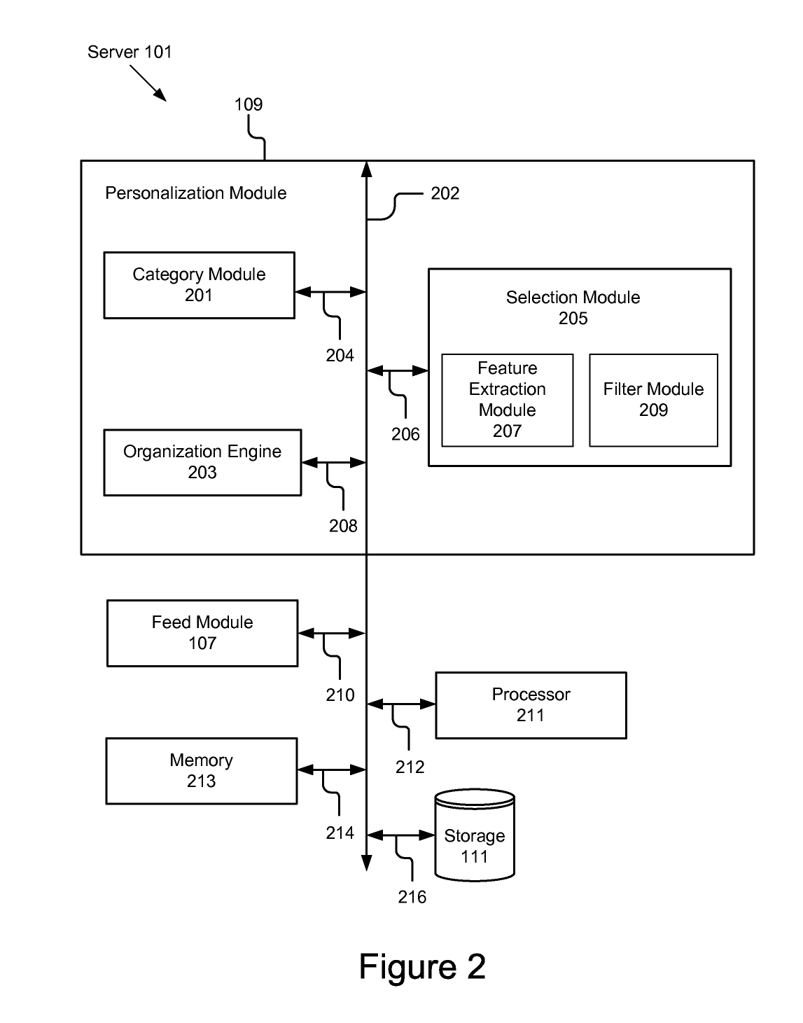

The personalization module 109 is code and routines that, when executed by a processor (not pictured), processes the social information feed to generate a personalized feed for a user 125a, 125b, 125n subject to user consent. For example, the personalization module 109 is a feed analyzer that communicates with the feed module 107 to receive the social information feed, communicates with a storage device (e.g., storage device 111) to retrieve profile information describing the user 125a, 125b, 125n and analyzes the social information feed based on the profile information describing the user 125a, 125b, 125n to generate a personalized feed for the user 125a, 125b, 125n. In one embodiment, the personalization module 109 is stored on a non-transitory memory associated with the server 101a, 101n. In other embodiments, the personalization module 109 is stored on a non-transitory memory associated with the third-party server 103 or the client device 125a, 125b, 125n. The personalization module 109 is communicatively coupled to one or more of the feed module 107, the storage device 111 and the network 105. The personalization module 109 is described in further detail below with reference to FIG. 2.

The third-party server 103 is a hardware server device. For example, the third-party server 103 is a conventional hardware server operated by a third-party, such as a website owner that wants to include a social component on the website. The third-party server 103 additionally comprises a processor (not pictured), memory (not pictured) and other components conventional to a hardware server device. In one embodiment, one or more of the feed module 107 and the personalization module 109 are comprised within the third-party server 103. For example, one or more of the feed module 107 and the personalization module 109 are stored on the memory of the third-party server 103 and executed by the processor of the third party server 103. In another embodiment, the third party server 103 comprises a memory (not pictured) that stores personal information about the user 125a, 125b, 125n of the client device 115a, 115b, 115n.

The client device 115a, 115b, 115n is any computing device. For example, the client device 115a, 115b, 115n is a personal computer (“PC”), smart phone, tablet computer (or tablet PC), etc. One having ordinary skill in the art will recognize that other types of client devices 115a, 115b, 115n are possible. In one embodiment, the system 100 comprises a combination of different types of client devices 115a, 115b, 115n. For example, a first client device 115a is a smart phone, a second client device 115b is a personal computer and a plurality of other client devices 115n is any combination of a personal computer, a smart phone and a tablet computer. The client device 115a, 115b, 115n comprises a processor (not pictured), a memory (not pictured) and other components conventional to a computing device. In one embodiment, one or more of the feed module 107 and the personalization module 109 are comprised within the client device 115a, 115b, 115n. For example, one or more of the feed module 107 and the personalization module 109 are stored on the memory of the client device 115a and executed by the processor of the client device 115a.

The client device 115a, 115b, 115n is communicatively coupled to the network 105. In one embodiment, the client device 115a, 115b, 115n is communicatively coupled to one or more of the third-party server 103 via the network 105 (along with one or more of the feed module 107 and the personalization module 109 if stored in the third-party server 103) and the server 101a, 101n via the network 105 (along with one or more of the feed module 107 and the personalization module 109 if stored in the server 101a, 101n, and the storage device 111). In another embodiment, the client device 115a, 115b, 115n comprises a memory (not pictured) that stores personal information about the user 125a, 125b, 125n of the client device 115a, 115b, 115n.

The user 125a, 125b, 125n is a human user of the client device 115a, 115b, 115n.

### Personalization Module 109

Referring now to FIG. 2, the personalization module 109 is shown in more detail. FIG. 2 is a block diagram of a server 101a, 101n that includes the personalization module 109, the feed module 107, the storage device 111, a processor 211 and a memory 213. The processor 211 comprises an arithmetic logic unit, a microprocessor, a general purpose controller or some other processor array to execute code and routines, etc. The processor 211 is coupled to the bus 202 for communication with the other components. Processor 211 processes data signals and comprises one or more of various computing architectures including a complex instruction set computer (CISC) architecture, a reduced instruction set computer (RISC) architecture, or an architecture implementing a combination of instruction sets. Although only a single processor is shown in FIG. 2, in other embodiments multiple processors are included. It will be obvious to one skilled in the art that other processors, operating systems, sensors, displays and physical configurations are possible. The processor 211 is communicatively coupled to the bus 202 via signal line 212.

The memory 213 stores instructions and/or data that are executed by the processor 211. For example, in one embodiment the memory 213 stores the feed module 107 described above with reference to FIG. 1. The memory 213 is communicatively coupled to the bus 202 for communication with the other components of the server 101a, 101n. In one embodiment, the instructions and/or data comprises code for performing any and/or all of the techniques described herein. The memory 213 is a dynamic random access memory (DRAM) device, a static random access memory (SRAM) device, flash memory or some other memory device known in the art. In one embodiment, the memory 213 also includes a non-volatile memory or similar permanent storage device and media such as a hard disk drive, a floppy disk drive, a CD-ROM device, a DVD-ROM device, a DVD-RAM device, a DVD-RW device, a flash memory device, or some other non-volatile storage device known in the art. The memory 213 is communicatively coupled to the bus 202 via signal line 214. In one embodiment, the memory 213 stores other components of the server 101a, 101n. For example, the memory 213 stores the personalization module 109.

The personalization module 109 comprises a category module 201, an organization engine 203 and a selection module 205. In the depicted embodiment, the personalization module 109 is communicatively coupled by the bus 202 for communication with the other components of the server 101a, 101n. For example, the personalization module 109 communicates with the storage device 111 via the bus 202 and signal line 216. The personalization module 109 communicates with the feed module 107 via the bus 202 and signal line 210. In one embodiment, the personalization module 109 comprises the feed module 107.

The category module 201 is code and routines for determining one or more categories to organize the social network feed. In one embodiment, the category module 201 organizes all the information included in the social network feed. In another embodiment, the category module 201 organizes a subset of the information included in the social network feed. For example, the category module 201 is a parser that parses the content of a post published in a social network and determines a category as a topic of the post. Persons having ordinary skill in the art will recognize that in other embodiments the category module 201 implements different techniques to determine one or more categories for the social network feed. For example, the server 101a, 101n is communicatively coupled to a display device (e.g., a computer monitor) to display graphical information. A human user of the server 101a, 101n is an administrator of the server 101a, 101n.

The storage device 111 or the memory 213 comprises graphical data for generating a Graphical User Interface (“GUI”). The category module 201 comprises a user interface module (not pictured) that communicates with the storage device 111 or the memory 213 to retrieve the graphical data. The user interface module communicates with the server 101a, 101n and/or the display of the server 101a, 101n to expose a GUI including fields, drop down boxes or any other graphical devices for the administrator to provide inputs specifying one or more categories. The administrator uses an input device (e.g., a keyboard, a touch screen, a pointing device, etc.) to provide the inputs. The user interface module communicates with the server 101a, 101n to receive these inputs from the administrator and stores the inputs in a non-transitory computer-readable memory such as the storage device 111 or the memory 213. In one embodiment, the one or more categories are provided by the administrator in real-time. In another embodiment, the one or more categories are prescribed by the administrator and stored in the memory 213. The categories include subject, such as football and hiking and also locations, such as the location of a post or the user.

In one embodiment, the one or more categories are specified by the user 125a, 125b, 125n similar to what is described above for the administrator providing such inputs, except that here the display is communicatively coupled to the client device 115a, 115b, 115n and the user interface module is communicatively coupled to the client device 115a, 115b, 115n. For example, the user 125a, 125b, 125n specifies one or more categories through an input device (e.g., a keyboard, a touch screen, a pointing device, etc.) of the client device 115a, 115b, 115n, causing the client device 115a, 115b, 115n to deliver the one or more categories to the category module 201 via the network 105. In one embodiment, the category module 201 stores the one or more categories specified by the user 125a, 125b, 125n in the storage device 111.

In one embodiment, the category module 201 determines the same categories for all the users 125a, 125b, 125n. In another embodiment, the category module 201 determines different categories for different users 125a, 125b, 125n. For example, the category module 201 determines a set of categories for each user 125a, 125b, 125n based on the profile information describing the user 125a, 125b, 125n. The category module 201 is communicatively coupled to the bus 202 via signal line 204. In one embodiment, the category module 201 provides the one or more categories to the organization engine 203 via the bus 202. In another embodiment, the category module 201 is communicatively coupled to the network 105.

The organization engine 203 is code and routines for organizing the social information feed into one or more categorized feeds. In one embodiment, the organization engine 203 organizes all the information included in the social network feed. In another embodiment, the organization engine 203 organizes a subset of the information included in the social network feed. For example, the organization engine 203 is a categorizer that parses the social information feed and categorizes the social information feed based on one or more categories to form one or more categorized feeds.

A categorized feed is a feed that includes all posts in the social information feed matching a category selected by a user 125a, 125b, 125n or an administrator of the server 101a, 101n. For example, the category is “weather” and the categorized feed includes all the public posts discussing weather from the social information feed. In one embodiment, posts listed in a categorized feed are sorted according to the published and/or updated time of the posts. For example, a post with a latest published and/or updated time is listed before other posts that are published and/or updated before the post. In another embodiment, items in the categorized feed are output one at a time as they are created. One having ordinary skill in the art will recognize that in other embodiments the organization engine 203 implements different techniques to organize the social information feed into one or more categorized feeds. For example, the organization engine 203 categorizes the social information feed based at least in part on the times that a post has been read and/or the number of comments that are attached to a post.

The organization engine 203 is communicatively coupled to the bus 202 via signal line 208. In one embodiment, the organization engine 203: (1) retrieves one or more categories from the category module 201 via the bus 202; (2) receives the social information feed (or a portion of the social information feed) from the feed module 107 via the bus 202; and (3) provides one or more categorized feeds to the selection module 205 via the bus 202. In another embodiment, the organization engine 203 retrieves the one or more categories from the memory 213 or the storage device 111 via the bus 202. In yet another embodiment, the organization engine 203 stores the one or more categorized feeds in the memory 213 or the storage device 111 via the bus 202.

The selection module 205 is code and routines for personalizing the categorized feed for a user. For example, the selection module 205 is a filter that filters the categorized feed to form a personalized feed for a user 125a, 125b, 125n subject to user consent. A personalized feed is a feed tailored for a particular user 125a, 125b, 125n. For example, a personalized feed is the result of filtering the categorized feed to select posts tailored for the user 125a, 125b, 125n. The selection module 205 comprises a feature extraction module 207 and a filter module 209. The selection module 205 is communicatively coupled to the bus 202 via signal line 206. In one embodiment, the selection module 205: (1) retrieves one or more categorized feeds from the organization engine 203 via the bus 202; (2) retrieves the profile information describing the user 125a, 125b, 125n from the storage device 111 via the bus 202; and (3) outputs a personalized feed to the user 125a, 125b, 125n or a third party via the network 105.

In one embodiment, the selection module 205 is configured to filter the social information feed to form a personalized feed. The social information feed is filtered without categorizing the social information feed to one or more categorized feeds. The selection module 205 retrieves the social information feed from the feed module 107 via the bus 202 and personalizes the social information feed to form a personalized feed. The selection module 205 outputs the personalized feed to the user 125a, 125b, 125n or a third party via the network 105.

The feature extraction module 207 is code and routines for extracting a feature for a user 125a, 125b, 125n. In one embodiment, the feature extraction module 207 extracts a feature based at least in part on the profile information describing a user 125a, 125b, 125n. For example, the feature extraction module 207 determines a feature for the user 125a, 125b, 125n based on meta-analysis of the profile information. In one embodiment, the feature is a keyword generated for the user 125a, 125b, 125n based at least in part on the profile information. For example, the feature is a keyword describing one or more of: an interest, a hobby, demographic information, website browsing history, querying history in a search engine, a website membership, a blog membership, a newsfeed subscription and a website connection. In one embodiment, the feature extraction module 207 extracts a plurality of features for the user 125a, 125b, 125n based on the profile information.

The feature extraction module 207 is communicatively coupled to the bus 202. In one embodiment, the feature extraction module 207 retrieves the profile information describing the user 125a, 125b, 125n from the storage device 111 via the bus 202. The feature extraction module 207 is also communicatively coupled to the filter module 209. In one embodiment, the feature extraction module 207 provides the extracted feature to the filter module 209. In another embodiment, the feature extraction module 207 stores the feature in the memory 213 or the storage device 111 via the bus 202.

The filter module 209 is code and routines for filtering a categorized feed to generate a personalized feed. For example, the filter module 209 filters one or more categorized feeds based at least in part on a feature extracted for a user 125a, 125b, 125n to generate a personalized feed for the user 125a, 125b, 125n matching the feature. In one embodiment, the filter module 209 filters the one or more categorized feeds based on a plurality of features extracted for the user 125a, 125b, 125n to generate a personalized feed matching the plurality of features. Examples of a personalized feed include, but are not limited to: a personalized feed that is configured to match a feature extracted for the user 125a, 125b, 125n; a personalized feed that is configured to satisfy a query from the user 125a, 125b, 125n; a personalized feed that is configured to match a topic that the user 125a, 125b, 125n subscribes to; and a personalized feed that is configured to match a geographical location (e.g., posts mentioning or otherwise relevant to a particular geographic location). In one embodiment, the personalized feed is organized to list posts based on the published and/or updated time of the posts. For example, the personalized feed is arranged such that a post with a later published time is listed before other posts that are published before the post.

In one embodiment, the filter module 209 is configured to filter the social information feed to generate a personalized feed. For example, the filter module 209 retrieves the social information feed from the feed module 107 via the bus 202 and filter the social information feed based at least in part on a feature extracted for a user 125a, 125b, 125n to generate a personalized feed for the user 125a, 125b, 125n.

The filter module 209 is communicatively coupled to the bus 202. In one embodiment, the filter module 209: (1) receives one or more categorized feeds from the organization engine 203 via the bus 202; and (2) receives a feature extracted for a user 125a, 125b, 125n from the feature extraction module 207. In another embodiment, the filter module 209 retrieves the one or more categorized feeds from the memory 213 or the storage device 111 via the bus 202.

In one embodiment, the filter module 209 is configured to receive a query from the user 125a, 125b, 125n via the network 105 and filter the one or more categorized feeds based at least in part on the query. In one embodiment, the query from the user 125a, 125b, 125n comprises one or more keywords specified by the user 125a, 125b, 125n. The filter module 209 outputs a personalized feed that matches the one or more keywords comprised within the query.

In another embodiment, the filter module 209 is configured to filter the one or more categorized feeds based at least in part on a geographical location and output a personalized feed matching the geographical location. In one embodiment, the geographical location is a location determined from the profile information describing the user 125a, 125b, 125n. For example, the geographical location is a mailing address listed in the profile information. In another embodiment, the geographical location is a location specified by the user 125a, 125b, 125n and stored in the profile information. For example, the user 125a, 125b, 125n determines a location by providing (1) a radius and (2) the coordinates of a point (e.g., the latitude and longitude of a point), so that the location is an area centered at the point within the radius. Alternatively, the user 125a, 125b, 125n provides two pairs of geographical coordinates to identify two corners in a diagonal of a rectangular bounding region (e.g., the southwest and northeast corners), and so, the rectangular bounding region determined by the two corners is the location specified by the user 125a, 125b, 125n. In one embodiment, the geographical location is specified using a specific place. For example, the user 125a, 125b, 125n specifies the geographical location as a specific place such as the physical home address. In yet another embodiment, the geographical location is the location of the client device 115a at the time that a post was created as determined by, for example, a global positioning system. This embodiment is subject to user consent. In some implementations, the user is prompted to explicitly allow use of the client device's 125a IP address. Further, the user may opt in/out of participating in such data collection activities. Furthermore, the collected data can be anonymized prior to performing the analysis to obtain the various statistical patterns described above.

In one embodiment, the organization engine 203 is communicatively coupled to the bus 202 via the signal line 208 to retrieve (1) one or more categories from the category module 201 and (2) a social information feed from the feed module 107. The organization engine 203 organizes the social information feed into one or more categorized feeds based at least in part on the one or more categories. In one embodiment, a user 125a, 125b, 125n subscribes to a category, and the organization engine 203 selects one of the one or more categorized feeds that matches the category as a personalized feed for the user 125a, 125b, 125n. For example, if the user 125a, 125b, 125n subscribes to the category “weather,” a categorized feed matching the category “weather” is selected as a personalized feed and sent to the user 125a, 125b, 125n via the network 105. In another embodiment, the organization engine 203 is communicatively coupled to the selection module 205 via the bus 202 to provide the one or more categorized feeds to the filter module 209 comprised within the selection module 205.

The feature extraction module 207 retrieves profile information describing the user 125a, 125b, 125n and extracts a feature based on the profile information. The feature extraction module 207 is communicatively coupled to the filter module 209 to provide the feature to the filter module 209.

The filter module 209 receives (1) the one or more categorized feeds from the organization engine 203; and (2) the feature from the feature extraction module 207. The filter module 209 filters the one or more categorized feeds based at least in part on the feature and outputs a personalized feed that matches the feature. In one embodiment the filter module 209 outputs the personalized feed to at least one user 125a, 125b, 125n. . For example, multiple users that share the same feature receive the same personalized feed. In another embodiment, the filter module 209 outputs the personalized feed to a third party. For example, a medical organization subscribes to a feed about medical related posts to determine the spread of the flu.

In one embodiment, the filter module 209 filters the one or more categorized feeds based at least in part on a query received from the user 125a, 125b, 125n and outputs a personalized feed matching the query. The feed is output either periodically or each time an item is created. In another embodiment, the filter module 209 filters the one or more categorized feeds based at least in part on a geographical location specified by the user 125a, 125b, 125n or derived from the profile information and outputs a personalized feed matching the geographical location. In yet another embodiment, the filter module 209 filters the one or more categorized feeds based on one or more of: the feature, the query and the geographical location. The filter module 209 outputs a personalized feed matching one or more of: the feature, the query and the geographical location.

In another embodiment, the selection module 205 is communicatively coupled to the feed module 107 via the bus 202 to retrieve a social information feed from the feed module 107. The social information feed is directly delivered to the selection module 205 without being processed by the organization engine 203. The feature extraction module 207 comprised within the selection module 205 extracts a feature describing the user 125a, 125b, 125n from the profile information retrieved from the storage device 111. The filter module 209 comprised within the selection module 205 filters the social information feed received from the feed module 107 based at least in part on the feature and outputs a personalized feed to the user 125a, 125b, 125n or a third party that matches the feature.

In one embodiment, the filter module 209 filters the social information feed based at least in part on a query received from the user 125a, 125b, 125n and outputs a personalized feed matching the query. In another embodiment, the filter module 209 filters the social information feed based at least in part on a geographical location specified by the user 125a, 125b, 125n or determined from the profile information and outputs a personalized feed matching the geographical location. In yet another embodiment, the filter module 209 filters the social information feed based on one or more of: the feature, the query and the geographical location. The filter module 209 outputs a personalized feed matching one or more of: the feature, the query and the geographical location.

### Methods

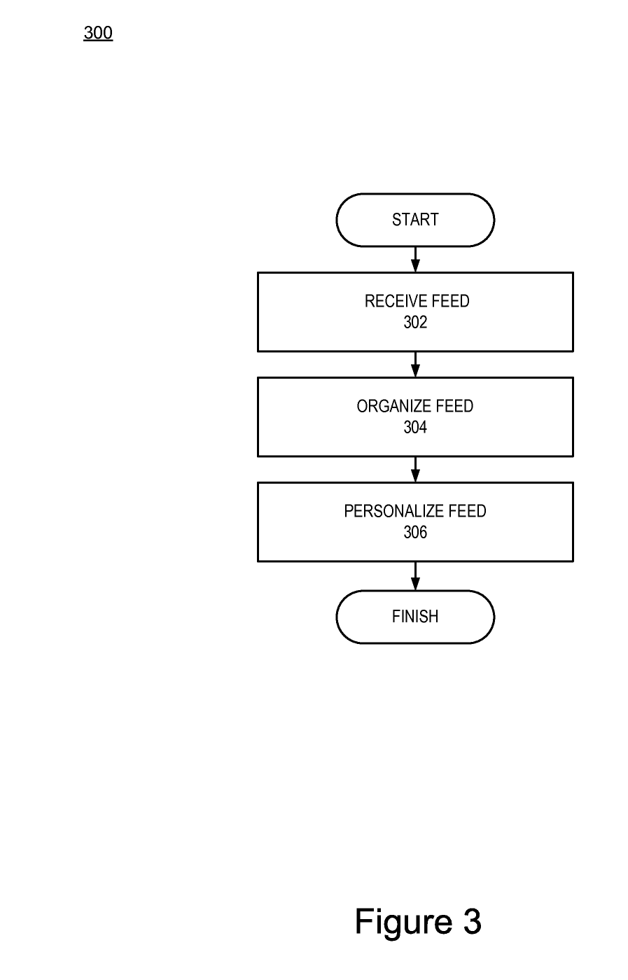

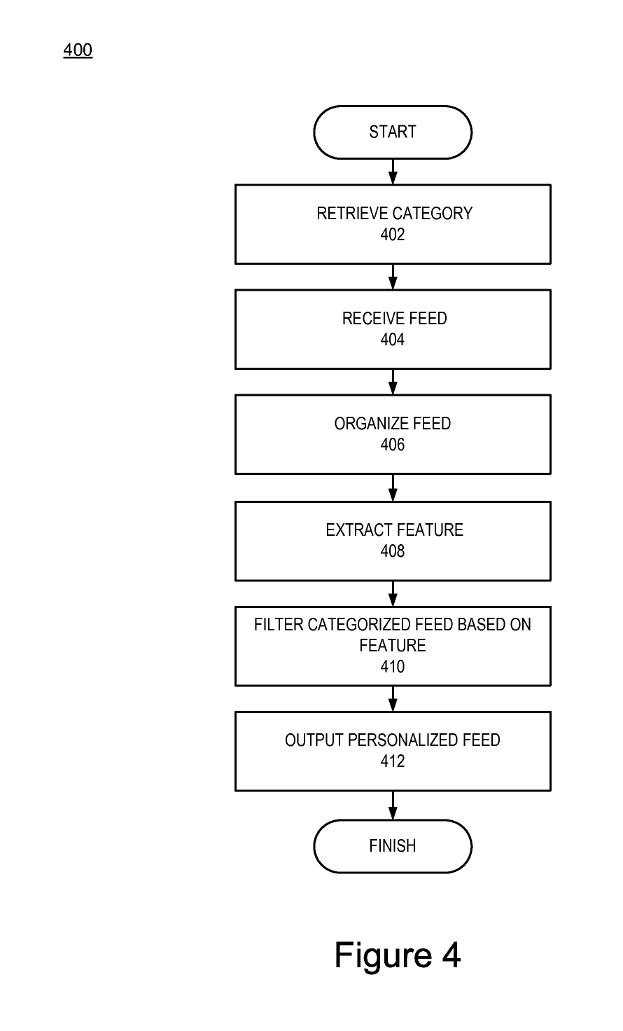

Referring now to FIGS. 3 and 4, various embodiments of the method will be described. FIG. 3 is a flow diagram 300 illustrating one embodiment of a method for tracking feeds in a social network. The feed module 107 receives 302 all or a portion of the social information feed (referred to herein as “the received social information feed”) from one or more of the social network software/application 116 and the content stream module 113. The feed module 107 sends the received social information feed to the personalization module 109. The personalization module 109 organizes 304 the social information feed into one or more categorized feeds. For example, the personalization module 109 organizes the social information feed into one or more categorized feeds based at least in part on one or more categories. In one embodiment, the one or more categories are determined as one or more topics derived by parsing content published in the social network, such as posts in a microblog. In another embodiment, the one or more categories are prescribed by an administrator of a server 101a, 101n or provided by the administrator in real-time. In yet another embodiment, the one or more categories are specified by the user 125a, 125b, 125n. The personalization module 109 personalizes 306 the one or more categorized feeds to form a personalized feed. In one embodiment, the personalization module 109 personalizes the one or more categorized feeds based at least in part on a feature describing the user 125a, 125b, 125n to generate a personalized feed matching the feature. In another embodiment, the personalization module 109 personalizes the one or more categorized feeds based at least in part on a query from the user 125a, 125b, 125n to generate a personalized feed matching the query. In yet another embodiment, the personalization module 109 personalizes the one or more categorized feeds based at least in part on a geographical location to generate a personalized feed matching the geographical location. The geographical location is a location specified by the user 125a, 125b, 125n or a location determined from the profile information describing the user 125a, 125b, 125n. In yet another embodiment, the personalization module 109 personalizes the one or more categorized feeds based on one or more of: the feature, the query and the geographical location to generate a personalized feed matching one or more of: the feature, the query and the geographical location.

FIG. 4 is a flow diagram 400 on one embodiment of a method for tracking feeds in a social network. The category module 201 determines one or more categories for categorizing the received social information feed. In one embodiment, the one or more categories are determined as one or more topics of posts published in the social network. In another embodiment, the one or more categories are provided by an administrator of a server 101a, 101n in real-time or prescribed by the administrator and stored in the memory 213. In yet another embodiment, the one or more categories are specified by a user 125a, 125b, 125n and stored in the storage device 111. In one embodiment, the category module 201 determines the same one or more categories for all the users 125a, 125b, 125n. In another embodiment, the category module 201 determines different categories for different users 125a, 125b, 125n. For example, the category module 201 specifies different categories for different users 125a, 125b, 125n based on the profile information describing the users 125a, 125b, 125n. In one embodiment, the category module 201 sends the one or more categories to the organization engine 203.

The organization engine 203 retrieves 402 the one or more categories from the category module 201. In one embodiment, the organization engine 203 retrieves the one or more categories from the memory 213. In another embodiment, the organization engine 203 retrieves the one or more categories from the storage device 111.

The feed module 107 receives 404 all or a portion of the social information feed from one or more of the social network software/application 116 and the content stream module 113. The feed module 107 delivers the social information feed to the organization engine 203.

The organization engine 203 receives the social information feed from the feed module 107. The organization engine 203 organizes 406 the social information feed into one or more categorized feeds based at least in part on the one or more categories. In one embodiment, the organization engine 203 parses the social information feed, categorizes the social information feed based on the one or more categories and generates one or more categorized feeds after the categorization. The organization engine 203 sends the one or more categorized feeds to the filter module 209.

The feature extraction module 207 retrieves profile information describing the user 125a, 125b, 125n from the storage device 111. The feature extraction module 207 analyzes the profile information and extracts 408 a feature describing the user 125a, 125b, 125n based at least in part on the profile information. In one embodiment, the feature extraction module 207 extracts a plurality of features for the user 125a, 125b, 125n based on the profile information. The feature extraction module 207 sends the extracted feature to the filter module 209. In one embodiment, the feature extraction module 207 stores the extracted feature in the storage device 111.

The filter module 209 receives the one or more categorized feeds from the organization engine 203. The filter module 209 receives the feature extracted for the user 125a, 125b, 125n from the feature extraction module 207. The filter module 209 filters 410 the one or more categorized feeds based at least in part on the feature to generate a personalized feed for the user 125a, 125b, 125n. In one embodiment, the filter module 209 filters the one or more categorized feeds based on a plurality of features extracted for the user 125a, 125b, 125n to form a personalized feed matching the plurality of features. In another embodiment, the filter module 209 receives a query from the user 125a, 125b, 125n. The filter module 209 filters the one or more categorized feeds based at least in part on the query to generate a personalized feed matching the query. In yet another embodiment, the filter module 209 receives a geographical location. The filter module 209 filters the one or more categorized feeds based at least in part on the geographical location to generate a personalized feed matching the geographical location. In yet another embodiment, the filter module 209 filters the one or more categorized feeds based on one or more of: the feature; the query; and the geographical location to generate a personalized feed matching one or more of: the feature; the query; and the geographical location. The filter module 209 outputs 412 the personalized feed to the user 125a, 125b, 125n or a third party via the network 105.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure of is intended to be illustrative, but not limiting, of the scope of specification, which is set forth in the following claims.

What is claimed is:

1. A method for tracking feeds in a social network, the method comprising:
retrieving a category;
receiving a social information feed from the social network;
organizing the social information feed into a categorized feed based at least in part on the category;
extracting a feature from a user query;
filtering the categorized feed based at least in part on the feature to generate a personalized feed; and
outputting the personalized feed.

2. The method of claim 1, wherein the category comprises a topic of a post published in the social network.

3. The method of claim 1, wherein filtering the categorized feed is further based at least in part on profile information describing the user.

4. The method of claim 3, wherein the profile information describing the user includes at least one of: demographic information, an interest, a hobby, an address, an educational background, a working experience, a social graph, a website membership, a blog membership, a website browsing history, a querying history in a search engine, a newsfeed subscription and a website connection.

5. The method of claim 3, wherein the feature comprises a keyword generated for the user based at least in part on the profile information.

6. The method of claim 1, wherein filtering the categorized feed is further based at least in part on a geographical location.

7. The method of claim 6, wherein the geographical location comprises one of a location specified by the user, a location determined from the profile information describing the user and a location of a user device at a time a post is created.

8. A computer program product comprising a non-transitory computer readable medium storing a computer readable program, wherein the computer readable program when executed on a computer causes the computer to perform steps comprising:
retrieving a category;
receiving a social information feed from the social network;
organizing the social information feed into a categorized feed based at least in part on the category;
extracting a feature from a user query;
filtering the categorized feed based at least in part on the feature to generate a personalized feed; and
outputting the personalized feed.

9. The computer program product of claim 8, wherein the category comprises a topic of a post published in the social network.

10. The computer program product of claim 8, wherein filtering the categorized feed is further based at least in part on profile information describing the user.

11. The computer program product of claim 10, wherein the profile information describing the user includes at least one of: demographic information, an interest, a hobby, an address, an educational background, working experience, a social graph, a website membership, a blog membership, a website browsing history, a querying history in a search engine, newsfeed subscription and a website connection.

12. The computer program product of claim 10, wherein the feature comprises a keyword generated for the user based at least in part on the profile information describing the user.

13. The computer program product of claim 8, wherein filtering the categorized feed is further based at least in part on a geographical location.

14. The computer program product of claim 13, wherein the geographical location comprises one of a location specified by the user, a location determined from the profile information describing the user and a location of a user device at a time a post is created.

15. A system for tracking feeds in a social network, the system comprising:
a feed module communicatively coupled to the social network, the feed module configured to receive a social information feed from the social network; and
a personalization module communicatively coupled to the feed module and configured to receive the social information feed from the feed module, the personalization module further configured to:
retrieve a category;
organize the social information feed into a categorized feed based at least in part on the category;
extract a feature from a user query;
filter the categorized feed based at least in part on the feature to generate a personalized feed; and
output the personalized feed.

16. The system of claim 15, wherein the category comprises a topic of a post published in the social network.

17. The system of claim 15, wherein the personalization module is further configured to filter the categorized feed based at least in part on profile information describing the user.

18. The system of claim 17, wherein the profile information describing the user includes one or more of: demographic information, an interest, a hobby, an address, an educational background, working experience, a social graph, a website membership, a blog membership, a website browsing history, a querying history in a search engine, a newsfeed subscription and a website connection.

19. The system of claim 17, wherein the feature comprises a keyword generated for the user based at least in part on the profile information describing the user.

20. The system of claim 15, wherein the personalization module is further configured to filter the categorized feed based at least in part on a geographical location.
